(19) United States
(12) Patent Application Publication
(10) Pub. No.: US 2016/0301854 A1
(43) Pub. Date: Oct. 13, 2016

(54) FOCUS DETECTION APPARATUS, AND CONTROL METHOD THEREOF AND STORAGE MEDIUM

(71) Applicant: CANON KABUSHIKI KAISHA, Tokyo (JP)

(72) Inventor: Ayumi Kato, Kawasaki-shi (JP)

(21) Appl. No.: 15/090,739

(22) Filed: Apr. 5, 2016

(30) Foreign Application Priority Data
Apr. 9, 2015 (JP) 2015-080349

(51) Int. Cl. H04N 5/232; G06T 7/00; G02B 15/14; H04N 5/235

(52) U.S. Cl. CPC H04N 5/23212; H04N 5/23296; H04N 5/2353; G06T 7/0069; G02B 15/14

(57) ABSTRACT

A focus detection apparatus includes a setting unit configured to set a plurality of focus detection areas for an image captured by photo-electrically converting an object image formed by an imaging optical system; a generation unit configured to, regarding each of the plurality of focus detection areas, detect information related to a distance to an object included in each of the plurality of focus detection areas, and generate a map expressing the information related to distance of each object; a determination unit configured to detect whether or not a moving object is included in each of the plurality of focus detection areas, and using detected information, determine a moving object condition; and an update unit configured to update the map based on the moving object condition determined by the determination unit.

### BACKGROUND OF THE INVENTION

1. Field of the Invention

The present invention relates to a focus detection apparatus that uses image signals obtained with an image sensor to create a distance map of distance to an object.

2. Description of the Related Art

Conventionally, a capturing apparatus is known that is capable of obtaining information related to distance to a desired object by processing a captured image. This information related to distance is updated as needed when a desired object or the capturing apparatus moves, and is updated in a case where movement was detected. This sort of capturing apparatus, for example, is installed in a vehicle such as an automobile, and is used in order to process an image in which a preceding vehicle or the like running in front of the vehicle of the capturing apparatus was captured, to detect a distance from the vehicle of the capturing apparatus to a desired object such as the preceding vehicle.

In order to satisfactorily obtain information related to distance, it is necessary to set a depth of field deep enough that objects in a screen do not become excessively blurred. Also, in order for more objects to be included in the screen, it is necessary to set a wide angle of view (Japanese Patent Laid-Open No. 2006-322795).

Also, in this sort of capturing apparatus, a plurality of frames for distance calculation (referred to below as distance measuring frames) are set, and for each distance measuring frame, a distance is calculated between the capturing apparatus and a desired object to be captured within the distance measuring frame. When doing so, in order to obtain information related to distance more quickly, it is also possible to reduce the calculation load by limiting the number of distance measuring frames.

However, with the above-described conventional technology disclosed in Japanese Patent Laid-Open No. 2006-322795, although there is the advantage that it is possible to include all objects in the screen within a predetermined depth of field, there is also the problem that a smaller aperture is set in order to increase the depth of field of the object, so the image is likely to darken. When the image darkens, the accuracy of information related to distance worsens.

Also, with the technology disclosed in Japanese Patent Laid-Open No. 2006-322795, although there is the advantage that it is possible to include many objects in the screen, there is also the problem that because the angle of view is increased, the object for which information related to distance is to be obtained is captured at a small size. When the object is captured at a small size, the accuracy of information related to distance worsens due to inadequate resolution of the image sensor.

Also, in a conventional capturing apparatus, there is the problem that many calculations are necessary in order to obtain information related to distance for a plurality of distance measuring frames in a screen, so for example in a case where the condition of an object has changed, it takes time to update information related to distance.

### SUMMARY OF THE INVENTION

The present invention has been made in consideration of the above problems, and in a case where information related to distance to an object having movement is obtained by processing a captured image, improves accuracy of the information related to distance and shortens the update time when updating the information related to distance.

According to a first aspect of the present invention, there is provided a focus detection apparatus, comprising: a setting unit configured to set a plurality of focus detection areas for an image captured by photo-electrically converting an object image formed by an imaging optical system; a generation unit configured to, regarding each of the plurality of focus detection areas, detect information related to a distance to an object included in each of the plurality of focus detection areas, and generate a map expressing the information related to distance of each object; a determination unit configured to detect whether or not a moving object is included in each of the plurality of focus detection areas, and using detected information, determine a moving object condition; and an update unit configured to update the map based on the moving object condition determined by the determination unit.

According to a second aspect of the present invention, there is provided a method for controlling a focus detection apparatus, comprising: setting a plurality of focus detection areas for an image captured by photo-electrically converting an object image formed by an imaging optical system; regarding each of the plurality of focus detection areas, detecting information related to a distance to an object included in each of the plurality of focus detection areas, and generating a map expressing the information related to distance of each object; detecting whether or not a moving object is included in each of the plurality of focus detection areas, and using detected information, determining a moving object condition; and updating the map based on the moving object condition determined in the determination.

Further features of the present invention will become apparent from the following description of exemplary embodiments (with reference to the attached drawings).

### BRIEF DESCRIPTION OF THE DRAWINGS

FIG. 1 is a block diagram of a capturing apparatus according to an embodiment of the present invention.

FIG. 2 is a flowchart of distance map updating in a capturing apparatus of one embodiment.

FIG. 3 shows an example of an image that was captured by a capturing apparatus of one embodiment.

FIGS. 4A and 4B show an example of an image that was captured by a capturing apparatus of one embodiment.

FIG. 5 is a flowchart of zoom setting in a capturing apparatus of one embodiment.

FIGS. 6A and 6B show an example of an image that was captured by a capturing apparatus of one embodiment.

FIG. 7 is a flowchart of aperture value setting in a capturing apparatus of one embodiment.

### DESCRIPTION OF THE EMBODIMENTS

Below, one embodiment of the present invention will be described in detail with reference to the accompanying drawings. In the present embodiment, an example is described in which, in a capturing apparatus installed in a vehicle, distance information (referred to below as a distance map) of the distance to an object that appears in a screen is updated. Specifically, a method for selecting an optimal zoom position and aperture value in order to improve accuracy of distance calculation is described.

Overall Schematic Configuration of Capturing Apparatus

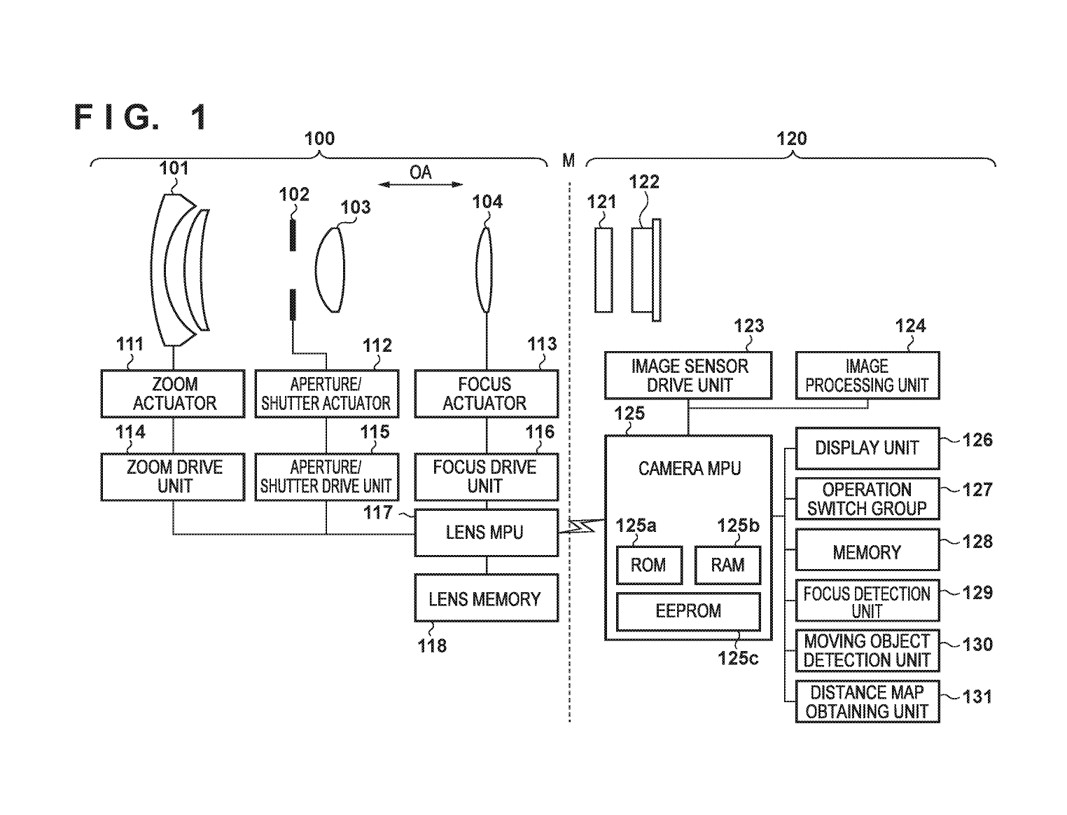

FIG. 1 is a block diagram that shows the configuration of a digital camera that is one embodiment of a capturing apparatus of the present invention. The digital camera of the present embodiment is an interchangeable lens-type single lens reflex digital camera, and has a lens unit 100 and a camera main body 120. The lens unit 100 is configured to be detachably connected to the camera main body 120 through a mount M indicated by a dotted line in the center of FIG. 1.

The lens unit 100 causes an object image to be formed, and has a first lens group 101, a shared aperture/shutter 102, a second lens group 103, a focusing lens group (referred to below as simply a ‘focusing lens’) 104, and a control unit described later. Thus the lens unit 100 has an imaging optical system that includes the focusing lens 104 and forms an image of the object.

The first lens group 101 is disposed at a front end of the lens unit 100, and is held so as to be capable of advancing or retreating in the direction of arrow OA, which is the direction of the optical axis (referred to below as the optical axis direction). Below, the optical axis direction OA is referred to as a z direction, and a direction viewing the capturing apparatus from the side of the object serves as a positive direction.

The shared aperture/shutter 102, by adjusting its opening diameter, performs light amount adjustment when image shooting is performed, and functions as an exposure time adjustment shutter when still image shooting is performed. The shared aperture/shutter 102 and the second lens group 103 are capable of advancing or retreating in the optical axis direction OA together as a single body, and realize a zoom function by operating in cooperation with advancing/retreating operation of the first lens group 101.

The focusing lens 104 performs focus adjustment by advancing/retreating movement in the optical axis direction. Here, in the present embodiment, among both ends in the maximum range that the focusing lens 104 can move, a position of the focusing lens 104 on an infinite side is referred to as an infinite end, and a position of the focusing lens 104 on a near side is referred to as a near end.

The control unit of the lens unit 100 has, as drive units, a zoom actuator 111, an aperture/shutter actuator 112, a focus actuator 113, a zoom drive unit 114, an aperture/shutter drive unit 115, and a focus drive unit 116. Also, the control unit of the lens unit 100 has a lens MPU 117 and a lens memory 118 as units configured to control the drive units.

The zoom actuator 111 performs zoom operation by driving the first lens group 101 and the third lens group 103 to advance/retreat in the optical axis direction OA. The aperture/shutter actuator 112 controls the opening diameter of the shared aperture/shutter 102 to adjust the shooting light amount, and performs exposure time control when shooting a still image. The focus actuator 113 performs focus adjustment by driving the focusing lens 104 to advance/retreat in the optical axis direction OA, and also has a function as a position detection portion configured to detect the current position of the focusing lens 104.

The zoom drive unit 114 drives the zoom actuator 111 according to zoom operation by a photographer or an instruction value of the lens MPU 117. The aperture/shutter drive unit 115 drives the aperture/shutter actuator 112 to control the opening of the shared aperture/shutter 102. The focus drive unit 116 drives the focus actuator 113 based on focus detection results, and performs focus adjustment by driving the focusing lens 104 to advance/retreat in the optical axis direction OA.

The lens MPU 117 performs all calculation and control for the imaging optical system, and controls the zoom drive unit 114, the aperture/shutter drive unit 115, the focus drive unit 116, and the lens memory 118. Also, the lens MPU 117 detects the current lens position, and gives notification of lens position information in response to a request from a camera MPU 125. The lens memory 118 stores various optical information necessary for automatic focus adjustment. Specifically, the lens memory 118 stores a correspondence relationship between the current position of the focusing lens 104 and a defocus amount, for example. Thus, when there has been a request from the camera MPU 125 to change the defocus amount by a predetermined amount, the lens MPU 117 is able to refer to the correspondence relationship that has been stored in the lens memory 118, and perform control of the focus actuator 113 so as to drive the focusing lens 104 by a distance corresponding to the predetermined defocus amount.

The camera main body 120 has an optical low pass filter 121, an image sensor 122, and a control unit described later. The optical low pass filter 121 reduces false color and moire of a shot image.

The image sensor 122 is configured with a C-MOS sensor and peripheral circuits thereof, and the C-MOS sensor has a pixel array in which one photo-electric conversion element has been disposed in each of light-receiving pixels, with m pixels in the horizontal direction and n pixels in the vertical direction. In the present embodiment, m has a larger value than n. In this case, the image sensor 122 is longer in the horizontal direction, but this example is not necessarily a limitation; n may have a larger value than m, or n and m may be equal.

The image sensor 122 is configured such that independent output of each pixel in the pixel array is possible. More specifically, the pixel arrangement of the image sensor 122 has a plurality of capturing pixels that each receive luminous flux that passes through the entire area of exit pupils of the imaging optical system that forms an image of an object, and these pixels generate the image of the object. Also, the pixel array further has a plurality of focus detection pixels that respectively receive luminous flux that passes through different exit pupil areas of the imaging optical system. The plurality of focus detection pixels as a whole are able to receive luminous flux that passes through the entire area of exit pupils of the imaging optical system, and correspond to one capturing pixel. For example, in the pixel array, within a group of two rows×two columns of pixels, a pair of G pixels to be disposed diagonally are left remaining as capturing pixels, and an R pixel and a B pixel are replaced with focus detection pixels.

The control unit of the camera main body 120 has an image sensor drive unit 123, an image processing unit 124, a camera MPU 125 that controls the entire camera main body 120, a display unit 126, an operation switch group 127, a memory 128, and a focus detection unit 129. The image sensor drive unit 123 controls operation of the image sensor 122, performs A/D conversion of an obtained image signal, and transmits the converted signal to the camera MPU 125. The image processing unit 124 performs y conversion, color interpolation, JPEG compression, and the like of the image obtained by the image sensor 122.

The camera MPU (processor) 125 performs all calculation and control for the camera main body 120. Thus, the camera MPU 125 controls the image sensor drive unit 123, the image processing unit 124, the display unit 126, the operation switch group 127, the memory 128, and the focus detection unit 129. The camera MPU 125 is connected to the lens MPU 117 through a signal line that has been disposed in the mount M. Thus, to the lens MPU 117, the camera MPU 125 issues a request to obtain the lens position, issues a request for zoom driving, shutter driving, or lens driving with a predetermined driving amount, and issues a request to obtain optical information unique to the lens unit 100, for example.

Built into the camera MPU 125 are a ROM 125a where a program that controls camera operation has been stored, a RAM 125b configured to store variables, and an EEPROM 125c configured to store parameters. Further, the camera MPU 125 executes focus detection processing by loading and executing the program stored in the ROM 125a. Details of the focus detection processing will be described later.

The display unit 126 is configured from an LCD or the like, and displays information related to a shooting mode of the camera, a preview image prior to shooting and a confirmation image after shooting, an in-focus state display image when performing focus detection, and the like. Also, the display unit 126 successively displays moving images during shooting. The operation switch group 127 is configured with a power switch, a release (shooting trigger) switch, a zoom operation switch, a shooting mode selection switch, and the like. The memory 128 of the present embodiment is a removable flash memory, and stores shot images. Also, the release switch is configured with a two-stage switch having a first stroke (below, SW1) that generates an instruction signal to start AE processing and AF operation performed prior to a shooting operation, and a second stroke (below, SW2) that generates an instruction signal to start an actual exposure operation.

The focus detection unit 129 performs focus detection by a focus detection method based on a blur evaluation value that is calculated from image information that was obtained by the image processing unit 124. Specifically, the focus detection method is a DFD-method AF, in which a blur evaluation value is calculated by performing calculation processing on two images that differ by a predetermined defocus amount. Note that in the present embodiment, the blur evaluation value is a value that indicates a blur state of a captured image, and is a value correlated with dispersion of a point spread function of the imaging optical system. Here, the point spread function is a function of the manner of spread after a point image has passed through the lens. On the other hand, dispersion of the point spread function of the imaging optical system is also correlated with the defocus amount. From the foregoing matters, it is understood that there is a correlation relationship between the blur evaluation value and the defocus amount. This correlation relationship is referred to as a blur evaluation value/defocus amount correlation.

In order to obtain the two images that differ by a predetermined defocus amount and are used in the DFD (Depth From Defocus) method AF (autofocus) performed by the focus detection unit 129, shooting is performed by changing, with control of the camera MPU 125, the shooting parameters such as focusing lens position, aperture amount, and focus distance, which affect the blur state of a captured image. If changing one or more of the shooting parameters, any of the parameters may be changed. In the present embodiment, a case is described where the two images that differ by a predetermined defocus amount are obtained by changing the focusing lens position.

A moving object detection unit 130 performs signal processing on image information that was obtained by the image processing unit 124, and determines whether or not there is a moving object, and determines the condition of a moving object that was detected. Also, a gyro sensor may be provided in order to detect a moving object. Thus, it is possible to detect movement of the camera itself, and by subtracting movement of the camera itself from image movement, it is possible to detect movement of an object. Also, as in the present embodiment, in a case where a camera is installed in a vehicle, detection results of a gyro sensor that has already been provided as one function of the vehicle may be used, without the camera having a gyro sensor.

Updating of Distance Map

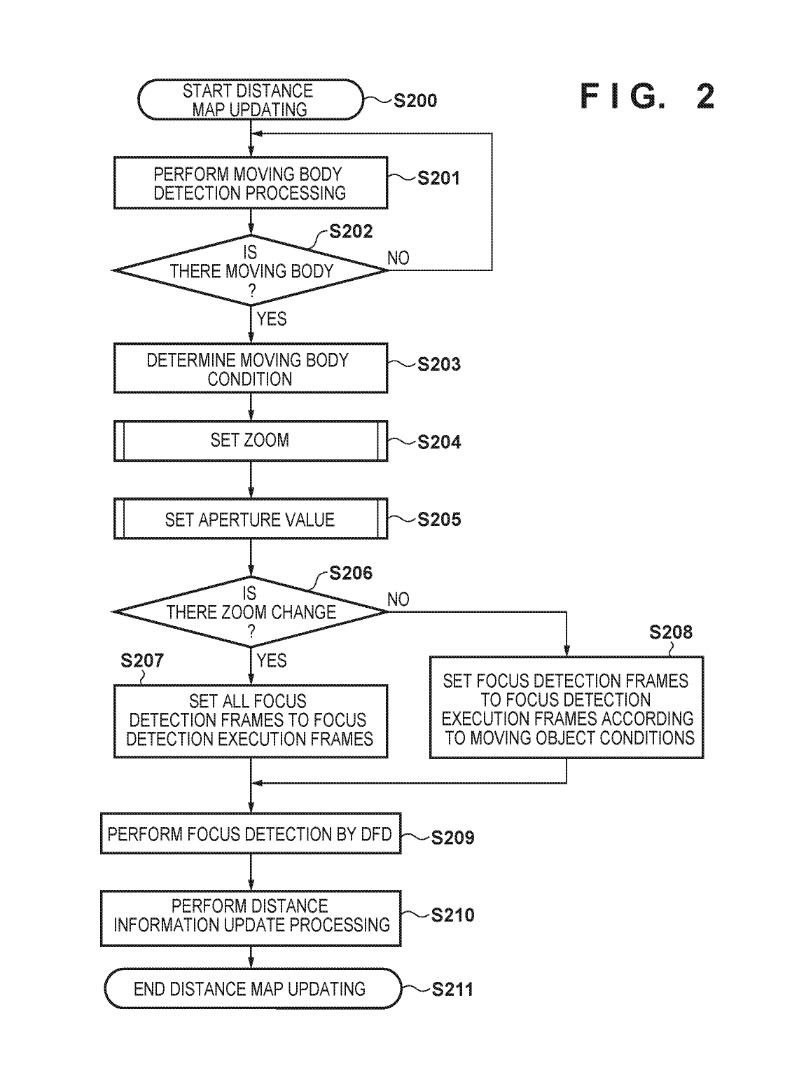

FIG. 2 is a flowchart that shows updating of a distance map of the capturing apparatus of the present embodiment. A control program related to this operation is executed by the camera MPU 125. Note that in FIG. 2, ‘S’ is an abbreviation of ‘step’.

When distance map updating is started in step S200, in step S201, the camera MPU 125 causes the camera to start a shooting operation, and the moving object detection unit 130 included in the camera MPU 125 performs moving object detection processing on sequential frames of a moving image that is a captured image. Here, the shooting operation indicates operation in which the image sensor 122 is exposed, and each frame of the captured image is stored in the RAM 125b. Also, the moving images that were shot are successively displayed in the display unit 126. Also, it is presumed that before performing this step, at least one captured image (one frame of a moving image) has been stored in the RAM 125b. Below, among at least one captured image that has been stored, an image having the most recent capture time is referred to as an old captured image. Further, it is presumed that a distance map corresponding to this old captured image has been created by a distance map obtaining unit 131 included in the camera MPU 125, and below this is referred to as an old distance map. Also, a distance map to be created in distance information update processing (step S210) described later is referred to below as a new distance map. The old distance map and the new distance map are both stored in the RAM 125b.

The moving object detection processing, for example, refers to processing to detect a moving object by comparing the old captured image with the captured image of step S201 and performing template matching. Note that the method of this moving object detection processing is not necessarily limited to template matching, and any technique may be adopted as long as it is possible to detect whether or not there is a moving object. Other information may be used such as detection results of a gyro sensor, optical flow, or object color, or a combination of these techniques may be used.

In the present embodiment, a case is described where it is presumed that moving object detection by the technique selected in step S201 is possible even in a state where an object having a shallow depth of field is blurred. A step of changing the zoom or aperture value settings when step S201 has been repeated for at least a predetermined time period may also be provided in preparation for a case where even though there is a moving object, the object is too blurred so the moving object cannot be detected. For example, when step S201 has been repeated for at least a predetermined time period, settings such that a moving object is more easily detected may be set, for example by setting wide angle of view for zoom during moving object detection processing, or setting a deep depth of field by increasing the aperture value.

Next, in step S202 it is determined whether or not a moving object was detected in the processing in step S201, and if a moving object was detected, processing proceeds to step S203 (Yes in step S202), and if a moving object is not detected, processing returns to step S201 and moving object detection processing is repeated (No in step S202). When a moving object was detected, in step S203, the moving object detection unit 130 included in the camera MPU 125 determines in detail the condition of the moving object that was detected. Determination of the condition of the moving object refers to obtaining information related to movement of the moving object, such as the quantity of moving objects included in the screen, the size of each moving object, movement direction within the screen of each moving object, movement speed within the screen in the x direction of each moving object, and movement speed within the screen in the y direction of each moving object. Note that the condition of the moving object is detected by comparing an old captured image to an image of a frame that has been newly shot.

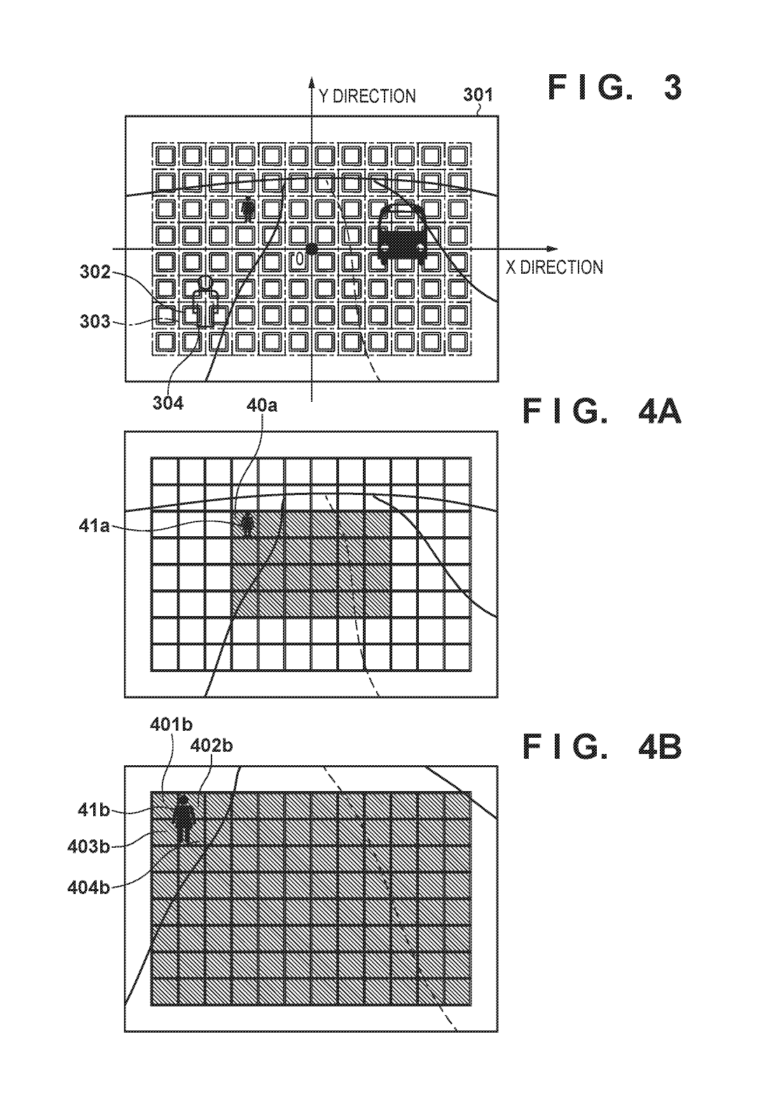

Here, the definition of the x direction and the y direction will be described with reference to FIG. 3. FIG. 3 shows an example of a shooting scene of the capturing apparatus of the present embodiment. When the capturing apparatus has been placed such that the z direction and the long side of the image sensor 122 are both parallel to the ground, the x direction in the present embodiment is a direction orthogonal to the z direction, and following a straight line that extends in the horizontal direction. The y direction in the present embodiment is a direction orthogonal to the z direction and the x direction respectively, and specifically is the vertical direction. As shown in FIG. 3, in the present embodiment, for ease of understanding the description, in the x direction the rightward direction of a shot image is defined as positive, in the y direction the upward direction in a shooting screen is defined as positive, and the intersection point of the x axis and the y axis is at the center position of the screen and is defined as an origin point O. Also, in the present embodiment, as described above it is presumed that information related to movement of a moving object can be obtained, but depending on the calculation accuracy of the technique selected in step S201 and the configuration of the capturing apparatus, there may be cases where information cannot be obtained. In such a case, it is preferable that zoom setting and aperture setting described later are performed based only on information that has been obtained.

Next, in step S204, the camera MPU 125 issues a request to the lens MPU 117 for zoom driving by a predetermined driving amount according to the condition of the moving object that was determined in step S203. Details of this zoom setting method will be described later. Next, in step S205, the camera MPU 125 issues a request to the lens MPU 117 for aperture/shutter driving by a predetermined driving amount according to the condition of the moving object that was determined in step S203. Details of this aperture value setting method will be described later. Note that when the lens unit 100 is caused to perform zoom driving and aperture driving during shooting of a moving image, that operation is expressed in the image that is being displayed in the display unit 126. Zoom driving and aperture driving of the lens unit 100 is merely an operation required in order to obtain a distance map, and is not required to be visible to the user. Therefore, a configuration is adopted in which the camera MPU 125, prior to causing the lens unit 100 to perform zoom driving and aperture driving, causes the display unit 126 to perform frozen display of an immediately prior image. Thus, it is possible to prevent the manner of zoom driving and aperture driving from being visible to the user.

Next, in step S206, the camera MPU 125 determines whether or not the zoom was changed in the zoom setting of above-described step S204. The determination in step S206 is necessary because there is a possibility that the zoom is not changed in step S204, but details of this will be described later. When the zoom was changed in step S204 (Yes in step S206), processing proceeds to step S207, and when the zoom has not been changed (No in step S206), processing proceeds to step S208.

Next, in step S207, when the zoom was changed in step S204 (Yes in step S206), the focus detection unit 129 included in the camera MPU 125 sets all focus detection frames to focus detection execution frames.

Here, the definition of focus detection frames (focus detection area) and focus detection execution frames in the present embodiment will be described using above-described FIG. 3. First, a focus detection frame is a frame disposed for a shot image 301 in the manner of a focus detection frame 302 indicated by double lines in FIG. 3, and is a frame that indicates a range subject to calculation in distance calculation performed in step S209 described later. A focus detection execution frame refers to a focus detection frame where the distance calculation described later is actually executed.

Also, in FIG. 3 an example is shown in which a total of 96 focus detection frames are provided, with 12 frames in the x direction and 8 frames in the y direction, but more focus detection frames or fewer focus detection frames may be provided. If more focus detection frames are provided, calculation accuracy improves but calculation time increases, and on the other hand, if fewer focus detection frames are provided, calculation time becomes faster but less precise so calculation accuracy decreases. Therefore, it is preferable to set an appropriate number of frames. Also, the disposed position of the center of each focus detection frame does not have to be centered horizontally and vertically, and the shape of the frame does not have to be a square.

Also, in FIG. 3, an example is shown in which there is a space between focus detection frames 302, but a configuration may also be adopted in which the focus detection frames are enlarged to eliminate the space, and a configuration may be adopted in which the focus detection frames are further enlarged such that they overlap. When the size of the focus detection frames is reduced, calculation time becomes faster but image information decreases so accuracy also decreases, and on the other hand, when the size of the focus detection frames is increased, the image information used for calculation increases and accuracy improves, but calculation time increases, and if the focus detection frames are too large perspective conflict occurs and accuracy also decreases. An appropriate focus detection frame size can be set by considering the above matters. In the description below, for ease of understanding, it is presumed that focus detection frames are adjacently touching, and all have the same size.

The reason for setting all of the focus detection frames to focus detection execution frames in step S207 will be described using FIGS. 4A and 4B. FIG. 4A shows a shooting scene prior to a zoom change, and FIG. 4B shows a shooting scene after a zoom change, with a narrower angle of view than in FIG. 4A. Also, the shooting scene in FIG. 4B has a more recent shooting time.

In FIGS. 4A and 4B, an object appears that is the same object in both drawings, with an object 41a being enlarged after a zoom change and then captured in the manner of an object 41b. In the shooting scenes in FIGS. 4A and 4B, it is detected that only the object 41a is moving. Also, a focus detection frame 40a is enlarged after the zoom change into an area including focus detection frames 401b, 402b, 403b, and 404b. That is, the number of focus detection frames corresponding to the desired object 41a is one frame in FIG. 4A, but is increased to four frames in FIG. 4B by the zoom change. Thus, improvement in the accuracy of distance calculation which is an object of the present embodiment is realized, and details of this will be described later.

Likewise, other focus detection frames also are enlarged by the zoom change from the diagonally lined portion shown in FIG. 4A to the diagonally lined portion shown in FIG. 4B, so distance calculation can be executed with good accuracy. The results of this accurate distance calculation are desired to be used for distance map updating performed in step S210 described later, so in a case where there was a zoom change as in the present step, it is necessary to set all of the focus detection frames to focus detection execution frames. Also, not only in a case of performing a zoom that narrows the angle of view as in the example in FIGS. 4A and 4B, but also in a case of performing a zoom that widens the angle of view, the angle of view of the image used to obtain the distance map is changed, so it is necessary to update the distance map for the entire screen, and so all of the focus detection frames are set to focus detection execution frames.

On the other hand, in step S208, when the zoom was not changed in step S204 (No in step S206), the focus detection unit 129 included in the camera MPU 125 sets the focus detection execution frames according to the moving object conditions that were determined in step S203. Specifically, a focus detection frame that includes even part of a moving object is set as a focus detection execution frame. That is, by again executing focus detection for only a portion that includes the moving object, the distance map is updated only for a portion that includes the moving object. Thus, the calculation load is reduced and the distance map can be updated quickly. Note that in consideration of the time period from detection of the moving object in step S201 until step S208, an excess of focus detection execution frames may be set in the positive direction of movement speed of the moving object.

Also note that in the present embodiment, the method of setting focus detection execution frames is described separately for setting all focus detection frames to focus detection execution frames (step S207) and setting a portion of the frames (step S208), but all of the focus detection frames may be set as focus detection execution frames regardless of whether or not there was a zoom change.

Next, in step S209, the focus detection unit 129 included in the camera MPU 125 performs focus detection by DFD. In this step, focus detection is performed in each focus detection execution frame that was set in step S207 or step S208, so distance information of each object included in each focus detection execution frame can be obtained.

In the focus detection by DFD, first, the position of the focusing lens is changed to obtain two images that differ by a predetermined defocus amount, and blur evaluation values are calculated from those images. When obtaining these two images, two images separated by several frames are used because it takes time to move the position of the focusing lens for several frames. Also, an image blurred due to shifting the focusing lens at this time is an image that does not have to be seen by the user, so an image immediately prior to shifting the focusing lens is shown frozen in the display unit 126. Afterward, the blur evaluation values that were obtained are converted to defocus amounts by referring to the above-described blur evaluation value/defocus amount correlation, and distance information is obtained from these defocus amounts. However, this correspondence relationship is stored in a table in the RAM 125b.

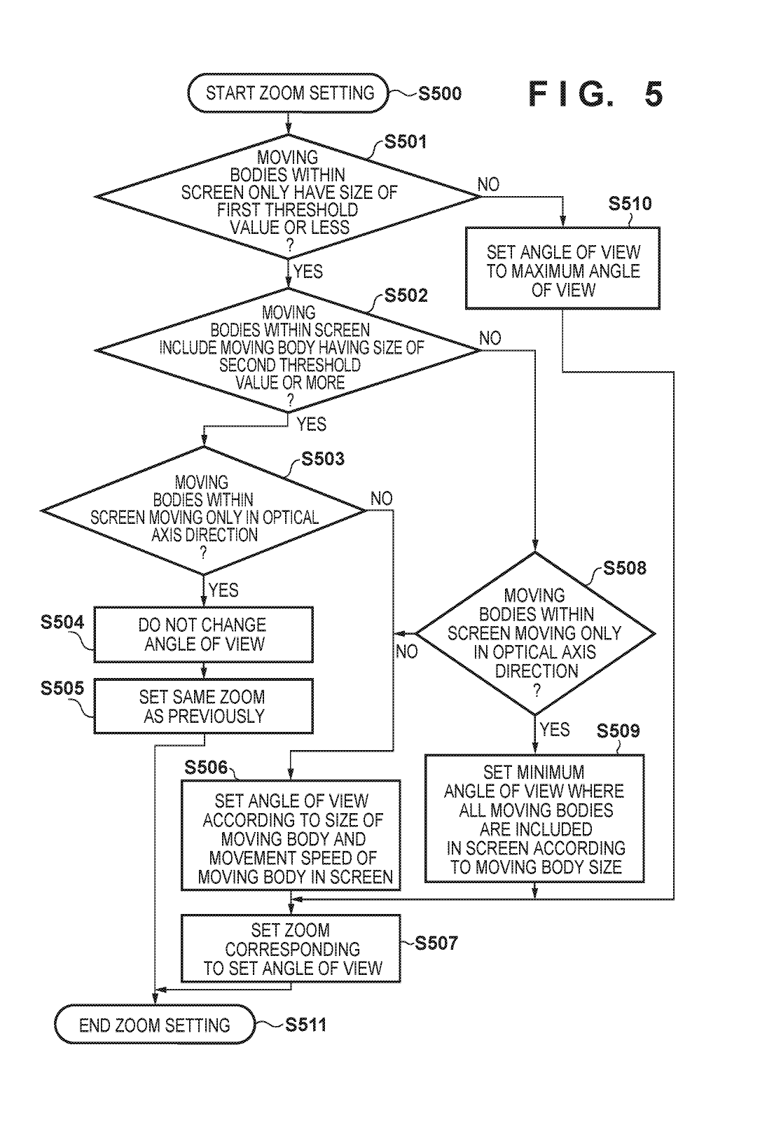

This sort of focus detection processing by DFD, more specifically, may be performed using a technique disclosed in Japanese Patent Laid-Open No. 2006-3803, or may be performed by another technique. Also, the focus detection performed in step S209 may be performed by a method other than DFD. For example, focus detection processing by an on-imaging plane phase difference AF detection method (referred to below as on-imaging plane phase difference method AF) may be performed. However, in order to perform this sort of on-imaging plane phase difference method AF, it is necessary for the image sensor 122 to have a plurality of capturing pixels that each receive luminous flux that passes through the entire area of exit pupils of the imaging optical system that forms an image of the object, and generate the image of the object. It is further necessary for the image sensor 122 to have a plurality of focus detection pixels that each receive luminous flux that passes through different exit pupil areas of the imaging optical system. Also, the focus detection unit 129 included in the camera MPU 125 obtains distance information by performing on-imaging plane phase difference method AF based on an offset amount of a pair of images formed by focus detection pixels by luminous flux that passes through a pair of pupil areas of the imaging optical system. The principles of the on-imaging plane phase difference method AF are the same as described with reference to FIGS. 5 to 7, 16, and so forth in Japanese Patent Laid-Open No. 2009-003122.

Next, in step S210, the distance map obtaining unit 131 included in the camera MPU 125 performs distance map update processing. Specifically, the update processing refers to replacing all or part of old distance map distance information stored by the RAM 125b with new distance information, and storing this in the RAM 125b as a new distance map. The RAM 125b may store the old distance map and the new distance map separately, or may overwrite the old distance map with the new distance map in order to reduce the capacity of the RAM 125b. Overwriting is used in the configuration of the present embodiment.

In the present embodiment, the RAM 125b stores one frame of a distance map as one unit of distance information, for both the old distance map and the new distance map. A distance map frame, for example, is a frame as indicated by the single-dotted chained line denoted by reference sign 303 in FIG. 3. In FIG. 3, an example is shown in which the size of a focus detection frame 302 is smaller than the size of a distance map frame 303, but these frames may have the same size, or their size relationship may be reversed, or the center position of these frames may be offset from each other. When the center positions of the focus detection frame 302 and the distance map frame 303 are different, it is preferable when reflecting distance information that was calculated in step S209 in the distance map frame to perform weighted addition of calculation results so as to match the size of the distance map frame. For ease of understanding the below description, it is presumed that the sizes of the focus detection frame and the distance map frame are the same, and that these frames have the same center position.

Here, an example of distance map update processing will be described using FIG. 3. For example, in a case where it was determined in above-described step S201 that only an object 304 is a moving object in a shot image 301, four focus detection frames are selected for the object 304, and distance information is calculated. That is, the distance map obtaining unit 131 included in the camera MPU 125 creates a new distance map by overwriting only information of the four distance map frames corresponding to these four focus detection frames onto the old distance map that was stored in the RAM 125b, and then ends update processing.

However, in the distance map updating it is important to pay attention to a case where the angle of view changed due to a zoom change. In the present embodiment, even when there was an angle of view change, it is assumed there is no change in the quantity and size of the distance map frame 303, and the distance map frame 303 is set for a shot image having a widest angle of view. Note that the angle of view does not have to be a widest angle of view, and the angle of view used to create the distance map may be changed according to the scene.

Here, using above-described FIGS. 4A and 4B, a case will be described where, in a state in which zooming has been performed to narrow the angle of view, the distance information that was calculated in step S209 is reflected in the old distance map to update the distance map. Frames indicated by double lines in FIGS. 4A and 4B are all distance map frames. Note that in FIGS. 4A and 4B, an example is shown in which a total of 96 distance map frames are provided, with 12 frames in the x direction and 8 frames in the y direction, but more distance map frames or fewer distance map frames may be provided. Also, in FIG. 4A it is assumed that shooting was performed at the widest angle of view.

As described above, after changing the zoom setting from FIG. 4A, the object is captured in an enlarged state shown in FIG. 4B. The diagonally lined portion shown in FIG. 4A corresponds to the diagonally lined portion shown in FIG. 4B. Consequently, it is preferable to update the information of each distance map frame after performing weighted addition on the calculation results of the diagonally lined portion of FIG. 4B so as to match the size of the distance map frames indicated by the diagonally lined portion of FIG. 4A.

When the distance map update processing is ended, the flow of processing proceeds to step S211, and distance map update processing is ended. The distance map update processing is repeatedly performed, so after repeated operation, the new distance map becomes an old distance map.

Zoom Setting

FIG. 5 is a flowchart that shows zoom setting of the capturing apparatus of the present embodiment. A control program related to this operation is executed by the camera MPU 125. Note that in FIG. 5, ‘S’ is an abbreviation of ‘step’.

When zoom setting is started in step S500, in step S501, the camera MPU 125 determines whether or not the size of a moving object included in the screen is only a first threshold value or less. Here, in the present embodiment, two threshold values, i.e. a first threshold value and a second threshold value, are provided regarding the size of the moving object. The first threshold value is larger than the second threshold value. In the present embodiment, changing of the zoom setting is performed in order to improve the accuracy of distance information by enlarging the object, because when an object for which distance information is to be obtained is captured at a small size, it is possible that resolution of the image sensor is inadequate and as a result accuracy of distance information will worsen.

Consequently, it is conceivable that an object with a smaller size than the second threshold value is an object for which accuracy of distance information is inadequate. Conversely, it is conceivable that an object with a size of the second threshold value or more is an object for which accuracy of distance information is adequate without changing the angle of view. Also, an object with a larger size than the first threshold value occupies too large a proportion in the screen, so it is necessary to change the zoom setting to wider angle of view in order to include all of that object.

Consequently, in step S501, when the size of the moving object included in the screen is only a moving object of the first threshold value or less (Yes in step S501), processing proceeds to step S502. Also, when one or more moving objects having a size larger than the first threshold value is included, processing proceeds to step S510 (No in step S501), and the angle of view is set to a maximum angle of view (step S510). Note that it is not absolutely necessary to set the angle of view to a maximum angle of view, and sufficient if shooting can be performed with a wider angle of view.

Next, in step S507, the camera MPU 125 issues a request to the lens MPU 117 for zoom driving by a driving amount corresponding to the angle of view that was set in step S510, and then ends the zoom setting operation (step S511).

In step S502, when the size of the moving object included in the screen is only a moving object of the first threshold value or less (Yes in step S501), the camera MPU 125 further determines whether or not there is at least one moving object of the second threshold value or more (step S502). When there is at least one moving object having a size of the first threshold value or less and the second threshold value or more within the screen, processing proceeds to step S503 (Yes in step S502), and when there is only a moving object having a size less than the second threshold value within the screen, processing proceeds to step S508 (No in step S502).

In step S508, when there is only a moving object having a size less than the second threshold value within the screen (No in step S502), the camera MPU 125 further determines whether or not all of the moving objects within the screen are moving in only an optical axis direction (referred to below as the z direction). When all of the moving objects are moving in only the z direction, processing proceeds to step S509 (Yes in step S508), and when movement in other than the z direction, i.e. the x direction or the y direction, is also included, processing proceeds to step S506 (No in step S508).

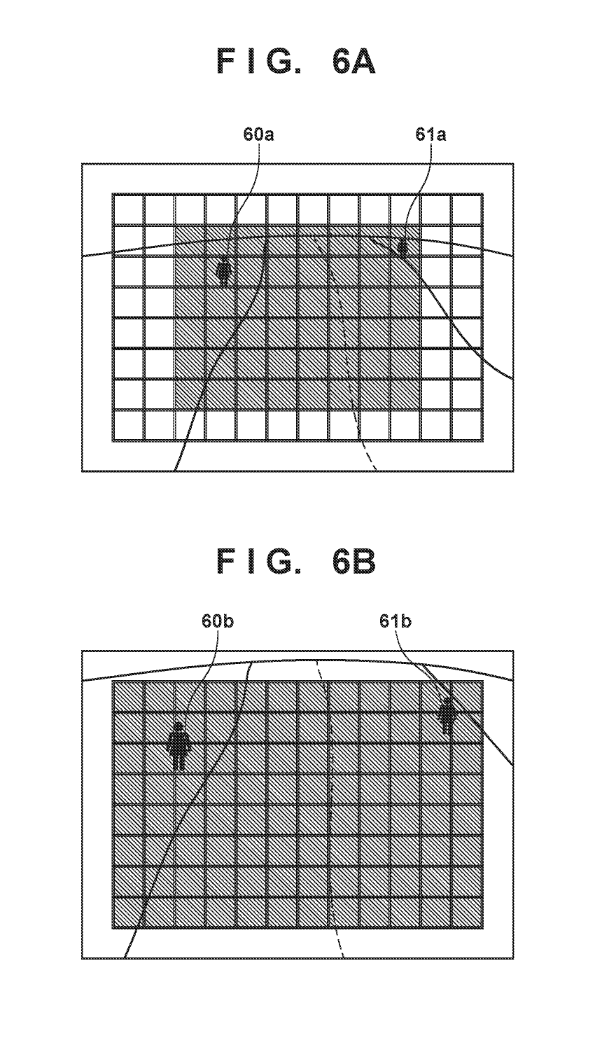

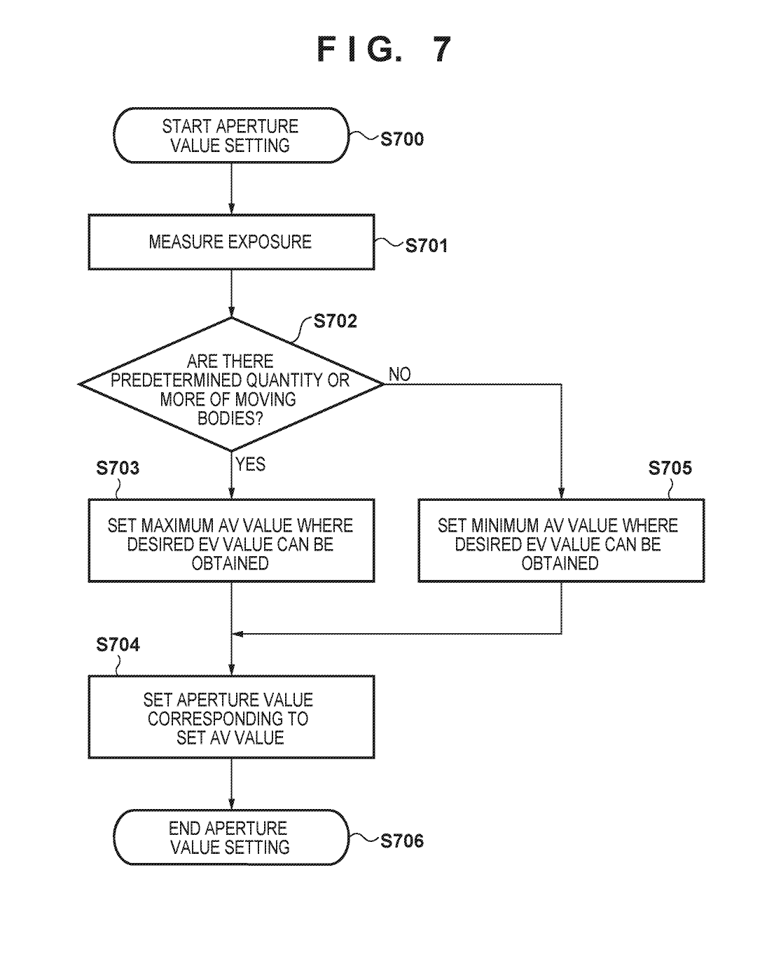

In step S509, when a moving object of a size smaller than the second threshold value within the screen is moving in only the z direction (Yes in step S508), the camera MPU 125, according to the size of the moving object, sets a minimum angle of view (telephoto side) at which all moving objects are included within the screen. An example of this will be described using FIGS. 6A and 6B.

FIG. 6A shows a shooting scene prior to a zoom change, and FIG. 6B shows a shooting scene after a zoom change, with a narrower angle of view than in FIG. 6A. Also, the shooting scene in FIG. 6B has a more recent shooting time. A common object appears in FIGS. 6A and 6B, with objects 60a and 61a being enlarged after a zoom change and then captured in the manner of objects 60b and 61b. In the shooting scenes in FIGS. 6A and 6B, it is assumed to be detected that only objects 60a and 61a are moving. Also, the diagonally lined portion shown in FIG. 6A is enlarged to the diagonally lined portion shown in FIG. 6B by a zoom change.

The minimum angle of view at which all of the moving objects are included within the screen in step S509 refers to a state as shown in FIG. 6B, for example. The angle of view is set such that the object 61a, which is at a further position from the origin point among the two objects within the screen, is certainly included in a range where focus detection frames are provided. Likewise in a case where three or more moving objects are within the screen, the angle of view is set such that the moving object at a position furthest from the origin point is included in a range where focus detection frames are provided.

In step S506, when a moving object of a size smaller than the second threshold value within the screen is moving in the x direction or the y direction (No in step S508), the camera MPU 125, according to the size of the moving object and movement speed within that screen, sets a minimum angle of view at which all moving objects are included within the screen. An example of this will be described using above-mentioned FIGS. 6A and 6B.

For example, when the object 61a in FIG. 6A is moving at a certain speed in the positive direction of the x axis, after performing zoom driving, the object 61a is positioned to the right side relative to the position of the object 61b in FIG. 6B. Therefore, if this movement is faster than a predetermined speed, there is a possibility that the object 61a will not be included in the focus detection range in FIG. 6B. Consequently, in the present step, the angle of view is set wider than the angle of view in FIG. 6B. This processing is performed to prevent an object from moving outside of the screen and no longer appearing, so that distance information can no longer be obtained.

Also, regarding the manner of selecting this angle of view, a configuration is preferable in which threshold values are provided for speeds of the moving object in the x direction and the y direction respectively, and the angle of view is set for each speed. The angle of view is set wider as the speed of the moving object increases. Also, in a case where the movement direction of all moving objects within the screen is towards the origin point, it is preferable to set a minimum angle of view at which all moving objects are included within the screen, as in above-described step S509. However, even if the direction of movement is towards the origin point, when the speed of the moving object is a predetermined speed or more, there is a possibility that the object will pass by the origin point to the opposite side, and no longer appear, so it is necessary to set a wide angle of view. As described above, the angle of view set in step S506 is equivalent to the angle of view that was set in above-described step S509, or the angle of view is set wider depending on the movement speed of the moving object in the x direction and the y direction.

When step S506 or S509 is ended, processing proceeds to above-mentioned step S507. Then, the camera MPU 125 issues a request to the lens MPU 117 for zoom driving by a driving amount according to the angle of view that was set in step S506 or S509, and ends the zoom setting operation (step S511).

In step S503, when there is a moving object having a size of the second threshold value or more and the first threshold value or less within the screen (Yes in step S502), the camera MPU 125 further determines whether or not all of the moving objects within the screen are moving in only the optical axis direction (referred to below as the z direction). When all of the moving objects are moving in only the z direction, processing proceeds to step S504 (Yes in step S503), and when movement in other than the z direction, i.e. the x direction or the y direction, is also included, processing proceeds to above-mentioned step S506 (No in step S503).

In step S504, the angle of view is not changed. The reason for this is that in step S504, a moving object having a size of the second threshold value or more and the first threshold value or less is included. A moving object having a size of the second threshold value or more and the first threshold value or less already has adequate accuracy of distance information, so it is not necessary to change the zoom setting. Also, when a moving object that already has adequate accuracy is enlarged too much, there is a possibility that the size will exceed the first threshold value.

However, in step S504, there is a possibility that a moving object that is smaller than the second threshold value is also included at the same time as a moving object having a size of the second threshold value or more and the first threshold value or less. When the angle of view is unchanged as in step S504, the accuracy of distance information of the moving object that is smaller than the second threshold value remains poor. In the present embodiment, focus is on the accuracy of the moving object having a size of the second threshold value or more and the first threshold value or less, and priority is given to not performing excessive enlargement, but priority may also be given to improving accuracy of a moving object that is smaller than the second threshold value.

In step S505, the camera MPU 125 issues a request to the lens MPU 117 to keep the current angle of view and not perform zoom driving, and ends the zoom setting operation (step S511).

Aperture Value Setting

FIG. 7 is a flowchart that shows aperture value setting of the capturing apparatus of the present embodiment. A control program related to this operation is executed by the camera MPU 125. Note that in FIG. 7, ‘S’ is an abbreviation of ‘step’.

When aperture value setting is started in step S700, in step S701, the camera MPU 125 performs exposure measurement. Exposure, i.e., an Ev value, is obtained in step S701. Said another way, appropriate exposure, under-exposure, over-exposure, and the degree thereof are recognized. Also, in the present embodiment, exposure conditions, namely a Tv value (shutter speed value), Av value (aperture value), and Sv value (sensitivity value) when measuring exposure in step S701 are set the same as for prior shooting, but predetermined conditions may also be designated. When step S701 is ended, processing proceeds to step S702.

In step S702, the camera MPU 125 determines whether or not a predetermined quantity or more of moving objects are included in the screen. When the predetermined quantity or more of moving objects are included in the screen, processing proceeds to step S703 (Yes in step S702), and when there are fewer than the predetermined quantity of moving objects, processing proceeds to step S705.

In step S703, a maximum Av value (aperture value) whereby a desired Ev value (exposure value) can be obtained is set. That is, a smaller aperture opening is set. In step S703, there are the predetermined quantity or more of moving objects included in the screen, so when the Av value is reduced and thus the depth of field becomes shallow, there is a possibility that a moving object will blur and moving object detection will not be possible. Consequently, in step S703, a large Av value (small aperture opening) is set in order to increase the depth of field.

Here, it is important to pay attention to the fact that there is a maximum settable value for the Av value (aperture value). The opening diameter of the shared aperture/shutter 102, which is a constituent element of the capturing apparatus, cannot be reduced beyond a predetermined value. Likewise, because of the configuration of the capturing apparatus, there is a minimum settable value (minimum exposure time) for the Tv value (shutter speed value), and there is a maximum settable value for the Sv value (sensitivity value). Consequently, the Av value is set so as to not be excessively large, in order to not exceed the minimum Tv value and the maximum Sv value, and obtain the desired Ev value.

When step S703 is ended, in step S704, the camera MPU 125 sets an aperture value corresponding to the Av value, and then ends aperture value setting (step S706).

In step S705, a minimum Av value whereby the desired Ev value can be obtained is set. In step S705, there are less than the predetermined quantity of moving objects included in the screen, so even when the Av value is reduced (aperture opening is increased) and thus the depth of field is reduced, it is possible to perform moving object detection of many moving objects. When the Av value is reduced, it is possible to brightly shoot an image even in a dark scene, so a small Av value is set in this step.

Here, it is important to pay attention to the fact that there is a minimum settable value for the Av value. The opening diameter of the shared aperture/shutter 102, which is a constituent element of the capturing apparatus, cannot be increased beyond a predetermined value. Likewise, because of the configuration of the capturing apparatus, there is a maximum settable value for the Tv value, and there is a minimum settable value for the Sv value. Consequently, the Av value is set so as to not be excessively small, in order to not exceed the maximum Tv value and the minimum Sv value, and obtain the desired Ev value.

For example, when shooting an extremely bright scene such as a snow scene, if an Av value is set such that there is a full-open aperture after setting the maximum Tv value or minimum Sv value, there are cases where blown-out highlights occur because the Ev value is too large, and so calculation accuracy of distance information decreases. In order to prevent this, a configuration is adopted in which a minimum Av value whereby the desired Ev value can be obtained is selected.

When step S705 is ended, in step S704, the camera MPU 125 sets an aperture value corresponding to the Av value, and then ends aperture value setting (step S706).

Thus, when a captured image is processed to update distance information of distance to an object having movement such as a preceding vehicle, it is possible to improve accuracy of the distance information by optimizing the depth of field and angle of view depending on moving object conditions.

Note that in the above embodiment, an example was described in which distance information is obtained from a defocus amount as information related to distance to an object, but a configuration may also be adopted in which a defocus amount itself is stored, and a defocus amount map is created instead of a distance map.

Above, preferred embodiments of the present invention were described, but the present invention is not limited by these embodiments, and can be variously altered or modified without departing from the gist thereof.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-080349, filed Apr. 9, 2015, which is hereby incorporated by reference herein in its entirety.

What is claimed is:

1. A focus detection apparatus, comprising:
a setting unit configured to set a plurality of focus detection areas for an image captured by photo-electrically converting an object image formed by an imaging optical system;
a generation unit configured to, regarding each of the plurality of focus detection areas, detect information related to a distance to an object included in each of the plurality of focus detection areas, and generate a map expressing the information related to distance of each object;
a determination unit configured to detect whether or not a moving object is included in each of the plurality of focus detection areas, and using detected information, determine a moving object condition; and
an update unit configured to update the map based on the moving object condition determined by the determination unit.

2. The focus detection apparatus according to claim 1,
wherein the update unit updates the map in a case where the determination unit detected that a moving object is included in at least one of the plurality of focus detection areas.

3. The focus detection apparatus according to claim 1,
wherein the update unit updates the map by, for a focus detection area including a moving object among the plurality of focus detection areas, detecting information related to distance to the object, and updating information related to distance to the object for the focus detection area including the moving object.

4. The focus detection apparatus according to claim 1, further comprising:
an adjusting unit configured to adjust a zoom position of the imaging optical system,
wherein when the update unit updates the map, the adjusting unit adjusts the zoom position of the imaging optical system to a wide angle side in a case where a moving object having a size larger than a first threshold value is included in the image.

5. The focus detection apparatus according to claim 4,
wherein the adjusting unit does not change the zoom position of the imaging optical system in a case where a moving object included in the image has a size of the first threshold value or less, and has a size of a second threshold value smaller than the first threshold value or more.

6. The focus detection apparatus according to claim 5,
wherein the adjusting unit adjusts the zoom position of the imaging optical system to a telephoto side in a case where a moving object included in the image has a size smaller than the second threshold value.

7. The focus detection apparatus according to claim 4,
wherein the adjusting unit adjusts the zoom position of the imaging optical system according to a movement direction of the moving object.

8. The focus detection apparatus according to claim 4,
wherein the adjusting unit adjusts the zoom position of the imaging optical system according to a movement speed of the moving object.

9. The focus detection apparatus according to claim 4,
wherein the adjusting unit adjusts the zoom position of the imaging optical system to a minimum angle of view where all moving objects of the image are included.

10. The focus detection apparatus according to claim 1, further comprising:
an aperture adjusting unit configured to adjust an aperture of the imaging optical system,
wherein when the update unit updates the map, the aperture adjusting unit adjusts the aperture of the imaging optical system to a minimum aperture value where a predetermined exposure value can be obtained in a case where a predetermined quantity or more of moving objects are included in the image.

11. The focus detection apparatus according to claim 10,
wherein the aperture adjusting unit adjusts the aperture of the imaging optical system to a maximum aperture value where the predetermined exposure value can be obtained in a case where the number of moving objects in the image is less than the predetermined quantity.

12. The focus detection apparatus according to claim 1,
wherein the generation unit detects information related to distance to the object using a DFD (Depth From Defocus) method.

13. The focus detection apparatus according to claim 1,
wherein the generation unit detects information related to distance to the object using an on-imaging plane phase difference method.

14. A method for controlling a focus detection apparatus, comprising:
setting a plurality of focus detection areas for an image captured by photo-electrically converting an object image formed by an imaging optical system;
regarding each of the plurality of focus detection areas, detecting information related to a distance to an object included in each of the plurality of focus detection areas, and generating a map expressing the information related to distance of each object;
detecting whether or not a moving object is included in each of the plurality of focus detection areas, and using detected information, determining a moving object condition; and
updating the map based on the moving object condition determined in the determination.

15. A computer-readable storage medium storing a program for causing a computer to execute each step of a method for controlling a focus detection apparatus, the control method comprising:
setting a plurality of focus detection areas for an image captured by photo-electrically converting an object image formed by an imaging optical system;
regarding each of the plurality of focus detection areas, detecting information related to a distance to an object included in each of the plurality of focus detection areas, and generating a map expressing the information related to distance of each object;
detecting whether or not a moving object is included in each of the plurality of focus detection areas, and using detected information, determining a moving object condition; and
updating the map based on the moving object condition determined in the determination.
